(19) United States
(12) Patent Application Publication
(10) Pub. No.: US 2003/0118188 A1
(43) Pub. Date: Jun. 26, 2003

(54) Apparatus and method for accessing material using an entity locked secure registry

(76) Inventors: David C. Collier, Gilroy, CA (US); Robert Fenny, Studio City, CA (US)

Correspondence Address: FRANK NGUYEN, 1341 Orleans Drive, Sunnyvale, CA, 94089, US

(21) Appl. No.: 10/036,128

(22) Filed: Dec. 26, 2001

(51) Int. Cl. H04L 9/00

(52) U.S. Cl. 380/277

(57) ABSTRACT

An aparatus and for accessing material using an entity-locked secure registry is described. A host includes material encrypted with at least one content key, a secure registry encrypted with a registry key and storing access and other information for the encrypted material, and a control module configured to decrypt the secure registry for retrieval of the access and other information if a correct entity identification is received.

### CROSS REFERENCE TO RELATED APPLICATIONS

This application claims priority to U.S. provisional application S. No. 60/___,___ filed Oct. 18, 2001 under Express Mail Label EL337672351US.

### FIELD OF THE INVENTION

The present invention generally relates to material accessing techniques and in particular, to an apparatus and method for accessing material using an entity-locked secure registry.

### BACKGROUND OF THE INVENTION

Providers of material demand compensation for the use of their material or content. Unauthorized use cheats these providers of their due compensation. Therefore, techniques for preventing such unauthorized use have been and continue to be developed.

Transfers of material are commonly performed over a secure channel such as those using authentication and key exchange techniques. Once the material is transferred, a recipient system should be secure so that authorized use, copying and/or transferring of the material is controlled and unauthorized use, copying and transferring of the material is prevented.

### OBJECTS AND SUMMARY OF THE INVENTION

Accordingly, two objects of the present invention are to provide an apparatus and method for accessing material that is secure.

Other objects are to provide an apparatus and method for accessing material that carefully controls authorized use, copying or transferring of material.

Still other objects are to provide an apparatus and method for accessing material that prevents or discourages unauthorized use, copying and transferring of material.

These and additional objects are accomplished by the various aspects of the present invention wherein briefly stated, one aspect is an apparatus for accessing material, comprising: a secure registry encrypted with a registry key and storing another key useful for decrypting material; and a control module configured to decrypt the secure registry using the registry key for retrieval of the another key if a correct entity identification is received.

Another aspect is a method for accessing material, comprising: decrypting a secure registry with a registry key; retrieving another key from said decrypted secure registry; and decrypting encrypted material using said another key to access said material.

Additional objects, features and advantages of the various aspects of the present invention will become apparent from the following description of its preferred embodiments, which description should be taken in conjunction with the accompanying drawings.

### BRIEF DESCRIPTION OF THE DRAWINGS

FIG. 1 illustrates, as an example, a host including an apparatus for accessing material in a file using an entity-locked secure registry, utilizing aspects of the present invention.

FIG. 2 illustrates, as an example, a system including an apparatus for accessing material in streaming media using an entity-locked secure registry, utilizing aspects of the present invention.

FIGS. 3˜9 illustrate, as examples, various hosts and systems including an apparatus for accessing material using an entity-locked secure registry, utilizing aspects of the present invention.

FIGS. 10˜14 illustrate, as examples, various methods for accessing material, utilizing aspects of the present invention.

### DETAILED DESCRIPTION OF THE PREFERRED EMBODIMENT

As used herein: the terms “audio-visual content” or “A/V content” includes audio, visual and other multimedia content including motion pictures, music, the spoken word, photos, and printed text; “material” and “content” may be used interchangeably, and includes A/V and other distributed content including computer programs or software; and “proprietary material” means material protected by contract or intellectual property law.

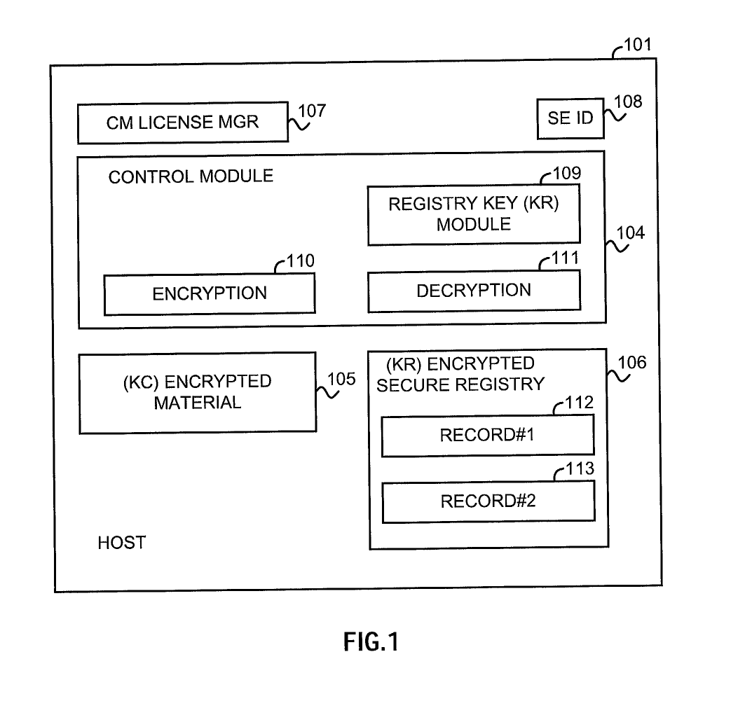

FIG. 1 illustrates, as an example, a host 101 including a control module 104, an encrypted material 105, and an entity-locked secure registry 106 that stores access and other information for the encrypted material 105. Also included in the host 101 are a control module license manager 107, and a sensed entity identification (“SE ID”) 108 preferably provided by a corresponding entity in response to a request from the control module 104. The host 101 may be a personal computer, an entertainment unit such as a set-top box and television set, a network appliance, a wireless communicating device such as a personal digital assistant (“PDA”) or other type of electronic device or system with adequate memory and computational power.

The sensed entity ID 108 uniquely identifies an entity associated with the secure registry 106. The entity may be the host 101, a portable hardware device connectable to the host 101, or a user of the host 101. In the case where the entity is the host 101, the sensed entity ID 108 is, for examples, a manufacturer's assigned serial number such as for a computer ID, a network interface card ID or a hard disk drive ID. Where the entity is a portable hardware device connectable to the host 101, the sensed entity ID 108 is, for examples, a smart card ID, a dongle, or a content storage unit (e.g., optical media) ID. On the other hand, in the case where the entity is a user of the host 101, the sensed entity ID 108 is, for examples, a credit card number of the user or a conventional user ID entered into an input device, such as a keyboard, by a user of the host 101, or a biometrics ID of the user such as the user's fingerprint or speech sensed by a biometrics device coupled to the host 101.

The control module 104 includes a registry key (KR) module 109, encryption module 110, and decryption module 111. The control module 104 is preferably implemented as a computer program running on a processor included in the host 101. Alternatively, it is implemented as one or more cooperative circuits, or a combination of hardware, software and/or firmware in a conventional manner. The control module 104 is preferably license-locked to the host 101 using a control module license manager 107 comprising commercially available software such as FLEXlm®, a product of GLOBEtrotter Software, Inc., a Macrovision company. Alternatively, it is license-locked to another entity such as a portable hardware device connectable to the host 101, or a user of the host 101. The registry key (KR) module 109 provides a registry key (KR) for decrypting the secure registry 106, and encrypting the decrypted version of the secure registry 106. The encryption module 110 and decryption module 111 respectively perform conventional encryption and decryption functions.

The encrypted material 105 comprises, for example, A/V or other content or proprietary material that has been encrypted for security purposes with at least one content key (KC). Although the decryption module 111 may decrypt the encrypted material 105 with the at least one content key (KC) in order for a user of the host 101 to use the material according to authorized usage rights, preferably, such decryption is performed in a plug-in module to a content player. In this latter case, the control module 104 securely transmits the at least one content key (KC) and relevant terms of a license to the plug-in module to facilitate content decryption and usage. Encrypted material 105 may be stored in host 101 or may be accessed from an inserted media storage unit such as optical media (e.g., CD or DVD media).

The secure registry 106 stores in records, such as record#1 112 and/or record#2 113, access and other information for the encrypted material 105, such as one or more keys that are useful for decrypting the encrypted material 105 and usage rights taking the form of a license defining how the decrypted version of the encrypted material 105 may be used. In one embodiment, the at least one content key (KC) used to decrypt the encrypted material 105 is stored in the secure registry 106. In another embodiment where the at least one content key (KC) is stored with or separate from the encrypted material 105 and encrypted with at least one license key (KL), the at least one license key (KL) is included in the secure registry 106 instead. Other information that may be stored in the secure registry 106 include confidential information particular to the host 101 or a user of the host 101, such as one or more private keys (KUP) and/or other cryptographic secrets. The secure registry 106 is referred to as being “secure”, because, among other things, it is maintained in an encrypted state except for a temporary period when a decrypted version of it is being used. It is also referred to as being “entity-locked”, because a registry key (KR) that is associated with the sensed entity ID 108 is used to generate a decrypted version of it in system or other temporary memory of the host 101 so that the decrypted version may be used, if the sensed entity ID 108 matches a reference entity ID stored in the secure registry 106 or retrieved from the registry key module 109 or provided by the control module license manager 107. Although it is possible that any one or all of the control module 104, encrypted material 105 and secure registry 106 may be inappropriately copied or transferred, the examples described in the various apparatuses and methods herein prevent these from being effectively used by another entity other than the one that the secure registry 106 is locked to or associated with.

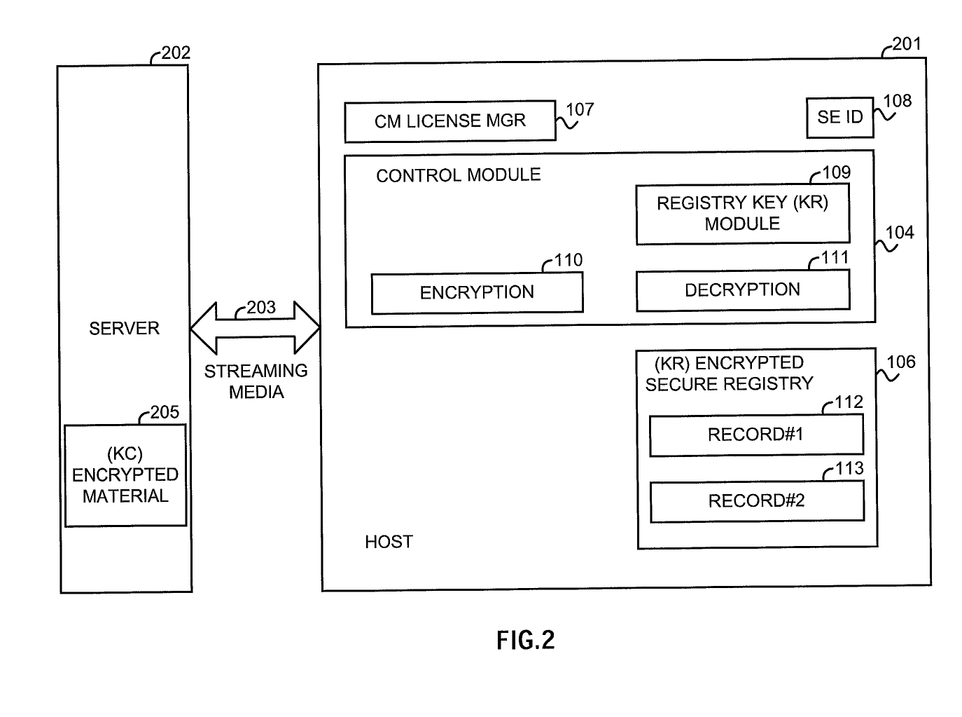

FIG. 2 illustrates a system including a host 201 and a server 202 communicating through a communication medium 203 such as the Internet. The host 201 is similarly configured as the host 101 of FIG. 1, except that in this case, instead of storing an encrypted material file such as encrypted material 105 in FIG. 1, it receives a copy of encrypted material 205 stored on the server 202 as streaming media, such as in an MPEG-4 bit stream, over the communication medium 203. The control module 104 prepares for receiving the streaming material by first retrieving the registry key (KR) from the registry key module 109, and decrypting the secure registry 106 with the registry key (KR) and retrieving one or more keys to access the encrypted material from the decrypted version of the secure registry 106 if a correct entity identification is received. The control module 104 determines whether or not the correct entity identification is received by comparing a reference entity ID against the sensed entity ID 108. If they match, then the control module 104 determines that the correct entity identification has been received. Processing of the received streaming media is then performed “on-the-fly” by the control module 104 (or a media player including a plug-in module) decrypting the received streaming media and using it according to usage rights also retrieved from the decrypted version of the secure registry 106.

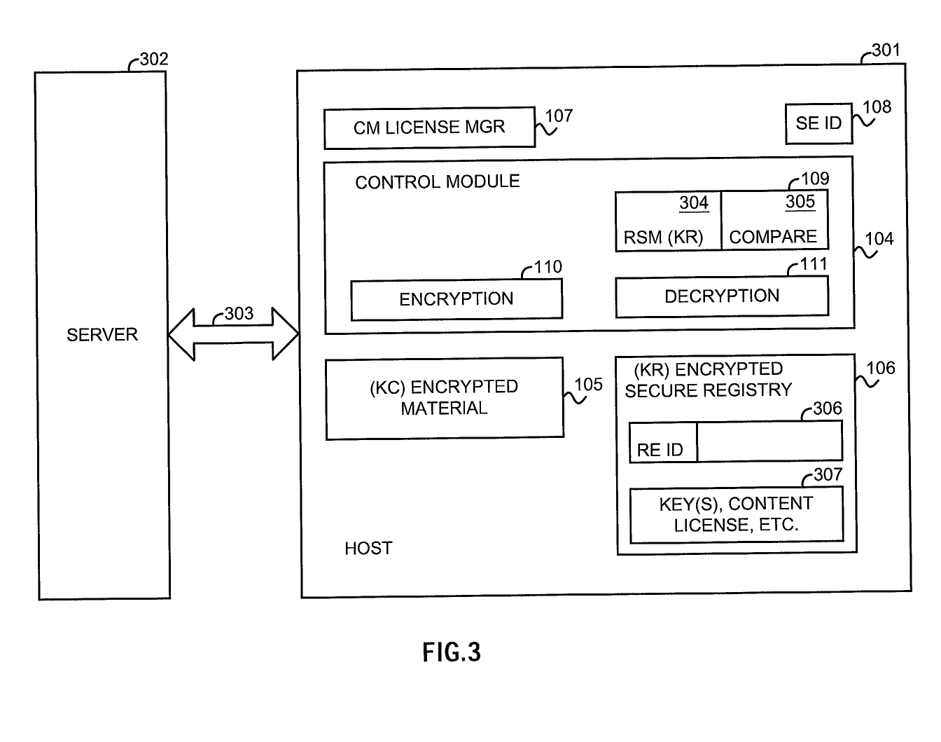

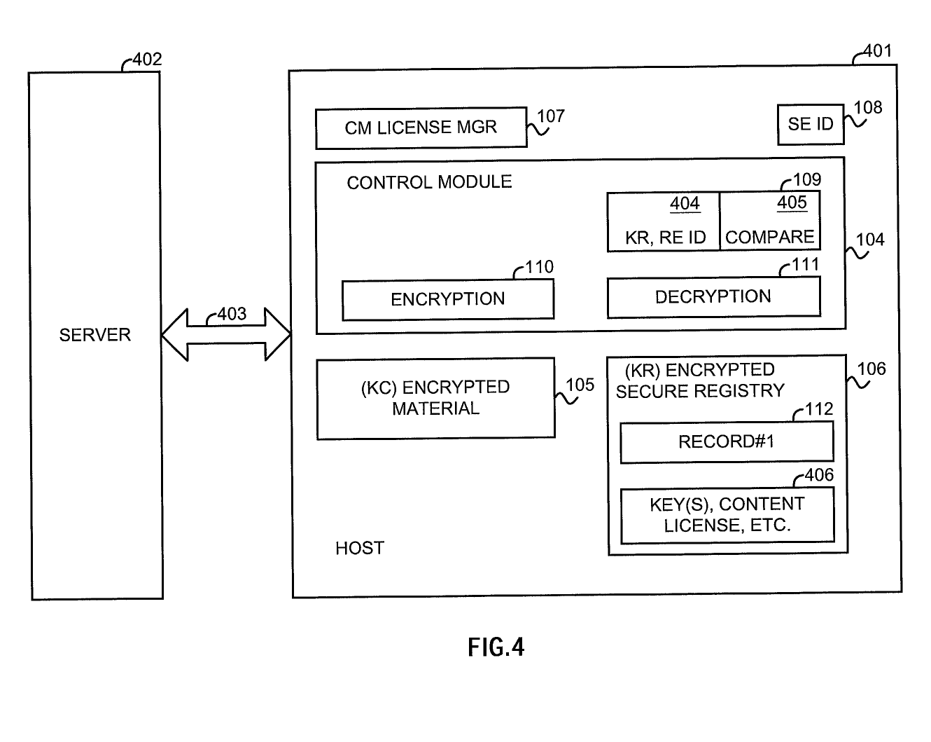

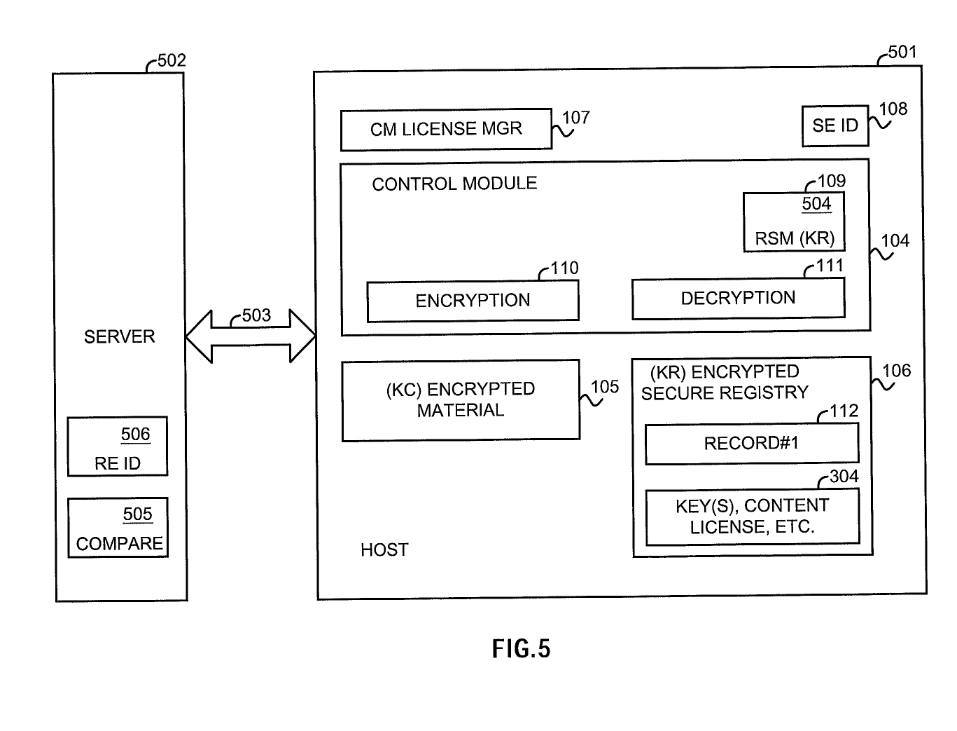

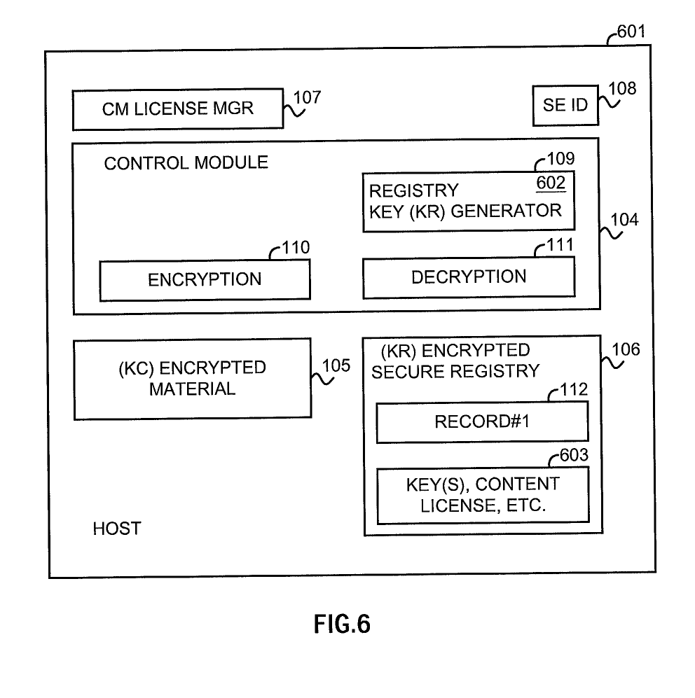

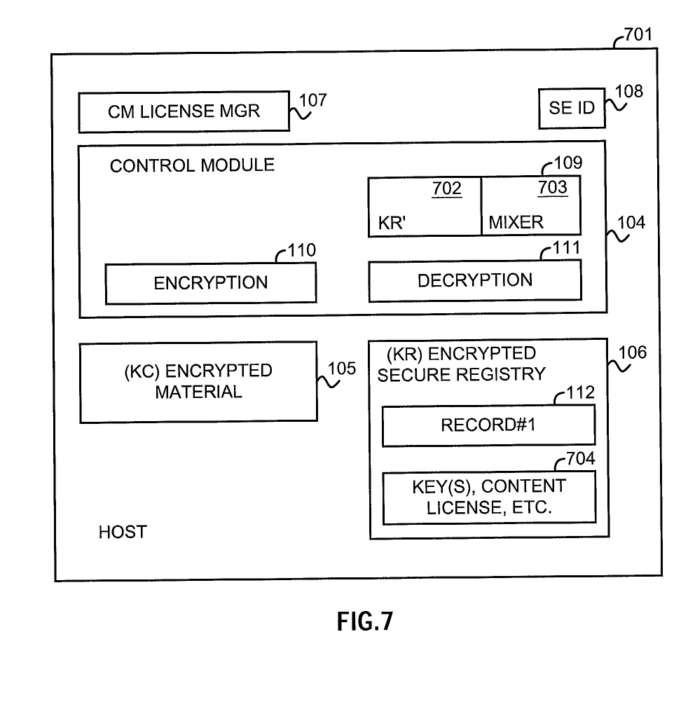

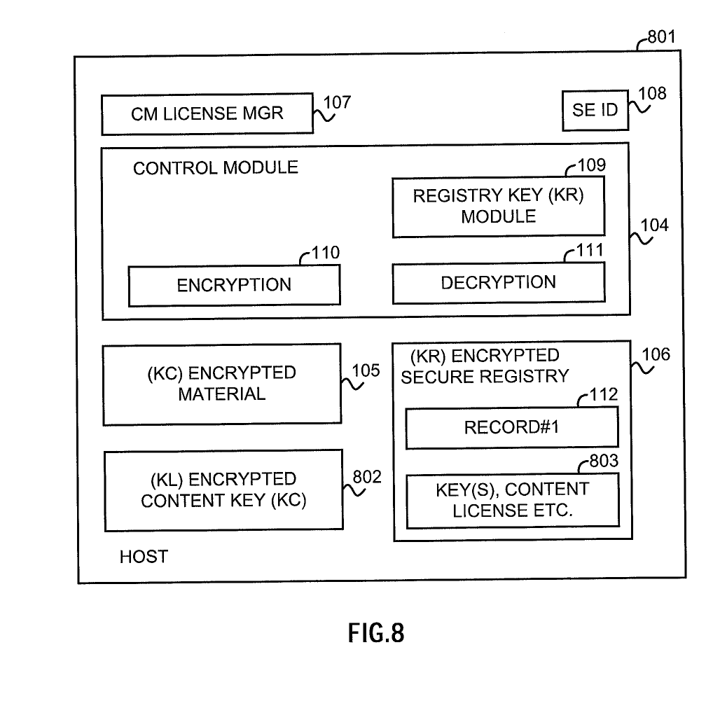

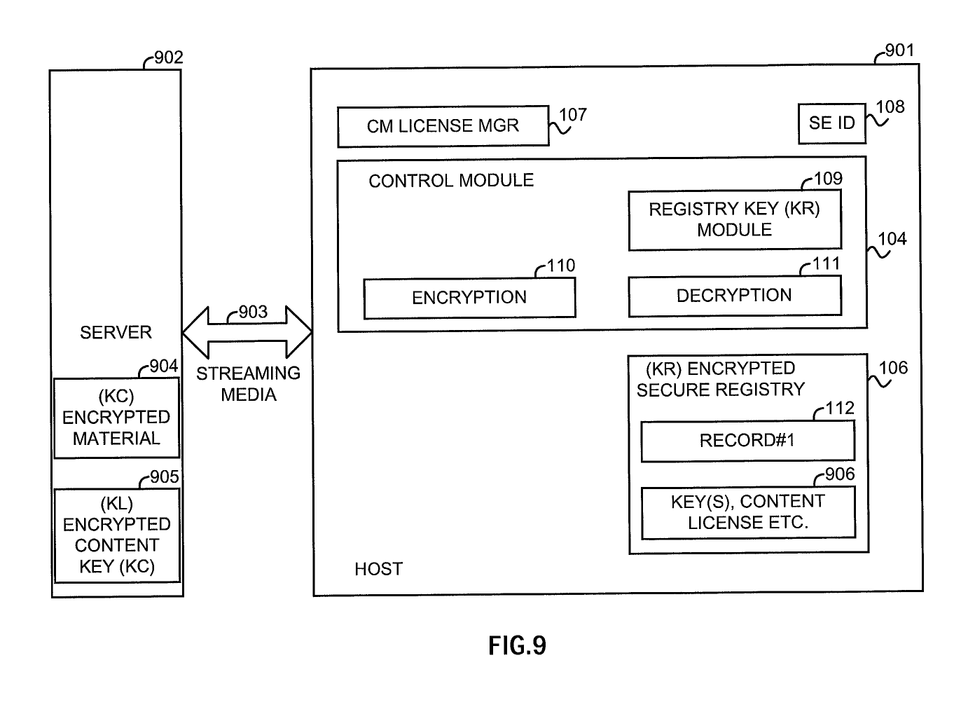

FIG. 3 illustrates another system including a host 301 and a server 302 communicating through a communication medium 303. The host 301 is one embodiment of the host 101 of FIG. 1, in which, the registry key (KR) module 109 comprises a replaceable software module (“RSM”) 304 providing a registry key (KR) for decrypting the secure registry 106, and a compare module 305 for comparing the sensed entity ID (“SE ID”) 108 against a reference entity identification (“RE ID”) stored in a record 306 of the secure registry 106. The replaceable software module 304 is preferably provided by the remote server 302, for examples, as a dynamic link library module (“.dll”), Java applet, Window COM object, or Active X object with the registry key (KR) included as data therein. It is referred to as being “replaceable,” because it is separately downloadable from the rest of the control module that is referred to herein as the control program. Once downloaded, it can be immediately used by the control program. Although the reference entity ID is stored in the secure registry 106 in this example, alternatively and preferably, it is provided along with the registry key (KR) in the replaceable software module 304 after the server providing the replaceable software module 304 to the host 301 receives the sensed entity ID 108 directly or indirectly from the host 301.

Before a user of the host 301 is allowed to use the encrypted material 105, the control module 104 first reads the registry key (KR) from the replaceable software module 304, “opens” the secure registry 106 by generating a decrypted version of it in memory using decryption module 111, reads the reference entity ID from record 306 in the decrypted version of the secure registry 106, reads the sensed entity ID 108, and compares the reference and sensed entity ID's using compare module 305.

If the reference and sensed entity ID's match, then the user is allowed to use the encrypted material 105 according to usage rights that are defined, for example, in a content license stored in record 307 of the decrypted version of the secure registry 106. To allow usage of the encrypted material 105, the control module 104 first retrieves a key from the decrypted version of the secure registry 106. In this example, the retrieved key is at least one content key (KC) that is used by the decryption module 111 to generate a decrypted version of the encrypted material 105 for use.

On the other hand, if the reference and sensed entity ID's do not match, then the user is not allowed to use the encrypted material 105. In particular, in such case, the control module 104 (or a plug-in to a media or content player) does not decrypt the encrypted material 105, and instead, displays an error message on the host screen indicating such failure to a user of the host 301. A log of the failed attempt may also be kept in a secret location.

It is prudent to change the registry key (KR) from time to time for security purposes. To do so, the remote server 302 first transmits a replaceable software module such as 304 that is linked to the control module 104. The replaceable software module provides two registry keys in this case, a new registry key and the old registry key. The old registry key is used to generate a decrypted version of the secure registry 106, and the new registry key is used to encrypt the decrypted version. The original secure registry 106 is then replaced with the newly encrypted version. Subsequent decrypting of the secure registry would then be performed using the new registry key.

FIG. 4 illustrates a system including a host 401 and a server 402 communicating through a communication medium 403. The host 401 is another embodiment of the host 101 of FIG. 1, in which, the registry key (KR) module 109 is integrated directly into the binary executable code of the control module 104 such that if either the registry key (KR) or reference entity ID (“RE ID”) included therein is subsequently changed, the entire control module 104 would have to be replaced. The registry key (KR) module 109 in this example also includes a compare module 405 for comparing the sensed entity ID (“SE ID”) 108 against the reference entity ID. The remote server 402 provided the binary executable code of the control module 104 to the host 401 after receiving information of the sensed entity ID 108 from the host 401. Access to the encrypted material 105 is then performed in a similar manner as described in reference to FIG. 3. Although the reference entity ID is integrated into the binary executable code of the control module 104 in this example, it could also be stored in one of the records of the secure registry 106, as in the host 301 of FIG. 3.

FIG. 5 illustrates a system including a host 501 and a server 502 communicating through a communication medium 503. The host 501 is another embodiment of the host 101 of FIG. 1. In the host 501, the registry key (KR) module 109 includes a replaceable software module 504 such as the replaceable software module 304 in FIG. 3. However, a reference entity ID 506 and compare module 505 are located on the remote server 502, instead of on the host 501. As in the prior examples, the reference entity ID 506 indicates the entity that is authorized to access contents of the secure registry 106, and is provided as the sensed entity ID 108 to the server 502 at the time of licensing the encrypted material 105 for use by the entity. In one embodiment, the entity itself provides the sensed entity ID 108 to the server 502 so as to define the reference entity ID 506. In another embodiment, an intermediary such as a separate licensing server provides the sensed entity ID 108 to the server 502.

When a user of the host 501 requests access to the encrypted material 105, the control module 104 transmits the sensed entity ID 108 to the server 502. The server 502 then compares the received sensed entity ID 108 against the reference entity ID 506 using the compare module 505. If the reference and sensed entity IDs match, then the server 502 sends a transaction approval to the host 501. The control module 104 of the host 501 then reads the registry key (KR) provided in the replaceable software module 504, decrypts the secure registry 106 with the registry key (KR), retrieves at least one content key (KC) stored in a record 304 of the secure registry 106, and uses the at least one content key (KC) to decrypt the encrypted material 105.

In a variation of the host 501, the registry key (KR) is integrated directly into the binary executable code of the control module 104 such as described in reference to FIG. 4, instead of in the replaceable software module 504. In all other respects, configuration and use of this variation is generally the same as the host 501 operating in cooperation with the server 502.

FIG. 6 illustrates a host 601 that is another embodiment of the host 101 of FIG. 1. In the host 601, the registry key (KR) module 109 comprises a registry key generator 602 that generates the registry key (KR) from the sensed entity ID 108 preferably in such a fashion that the generated registry key (KR) is unique to the sensed entity ID 108 (i.e., no other sensed entity ID generates the same registry key as the sensed entity ID 108) and repeatable (i.e., the same registry key output is generated each time for the same sensed entity ID input). In one embodiment, the registry key generator 602 is implemented as a pseudo-random number generator that generates the registry key (KR) as a pseudo-random number from the sensed entity ID 108 that is provided as a seed to the pseudo-random number generator. For security reasons, the algorithm for the pseudo-random number generator is kept secret.

Since the secure registry 106 is encrypted and decrypted with the registry key (KR) generated from the sensed entity ID 108, any other sensed entity ID (different than the sensed entity ID 108) provided to the registry key generator 602 will not generate a registry key (KR) capable of decrypting the secure registry 106 to read its contents. Consequently, access keys and other information related to the encrypted material 106, that are stored in the secure registry 106, are not available to an unauthorized entity. Although implementation of the registry key generator 602 adds some complexity to the registry key module 109, the elimination of a compare module such as 305 in FIG. 3, helps compensate somewhat for such added complexity.

FIG. 7 illustrates a host 701 that is another embodiment of the host 101 of FIG. 1. In the host 701, the registry key (KR) module 109 includes an embedded key (KR′) 702 and a mixer 703 that generates the registry key (KR) by mixing the embedded key (KR′) 702 and a sensed entity ID 108 (or a pseudo-random number generated from the sensed entity ID 108) preferably in such a fashion that the generated registry key (KR) is unique to the sensed entity ID 108 (i.e., no other sensed entity ID generates the same registry key as the sensed entity ID 108) and repeatable (i.e., the same registry key output is generated each time for the same sensed entity ID input). In one embodiment, the embedded key (KR′) 702 is provided in a replaceable software module such as 304 in FIG. 3 to the host 701 from a remote server. In another embodiment, the embedded key (KR′) 702 is integrated directly into the binary executable code of the control module 104, which is provided to the host 701 from a remote server. In both embodiments, the remote server can effectively change the registry key (KR) by providing a new and old embedded key in basically the same manner as described in reference to FIG. 3.

FIG. 8 illustrates a host 801 that is another embodiment of the host 101 of FIG. 1. In the host 801, the at least one content key (KC) used to decrypt the encrypted material 105 is itself, encrypted with at least one license key (KL) and provided in a file 802 along with the encrypted material 105 by a remote server. The at least one license key (KL), as its name suggests, is associated with a license providing usage rights to the encrypted material 105. The at least one license key (KL) and the license are stored, for example, in a record 803 of the secure registry 106, so that a user of the host 801 may only access the encrypted material 105 after the at least one license key (KL) has been retrieved from the secure registry 106, the decryption module 111 has decrypted the at least one content key (KC) using the retrieved at least one license key (KL), and the encrypted material 105 has been decrypted using the at least one content key (KC). The control module 104 (or plug-in to a media or content player) that decrypts the encrypted material 105 then controls usage of the decrypted version of the encrypted material 105 according to its corresponding content license retrieved from the secure registry 106. Access to the secure registry 106 for retrieval of the at least one license key (KL) and the content license is performed in the same manner as described, for example, in reference to FIG. 1, and other examples described herein as applicable.

FIG. 9 illustrates a system including a host 901 and a server 902 communicating through a communication medium 903. The host 901 is similarly configured as the host 201 of FIG. 2, for receiving a copy of encrypted material 904 stored on the server 902 as streaming media, such as in an MPEG-4 bit stream, over the communication medium 903. The encrypted material 904 is encrypted with at least one content key (KC), which in turn, is encrypted with at least one license key (KL). The host 901 is further configured to receive the encrypted at least one content key 905 such as, for example, in the IPMP (“Intellectual Property Management & Protection”) stream that is provided along with encrypted material in an MPEG-4 bit stream. U.S. Non-Provisional Patent Application Ser. No. __/___,___ entitled “Method, Apparatus And System for Securely Providing Material to a Licensee of the Material,” filed ______,___ 2001, assigned to the same assignee as the present invention and incorporated in its entirety herein by this reference, describes one such an example. Access and usage of the encrypted material 904 is then performed in a similar manner as described, for example, in reference to FIG. 8, and other examples described herein as applicable.

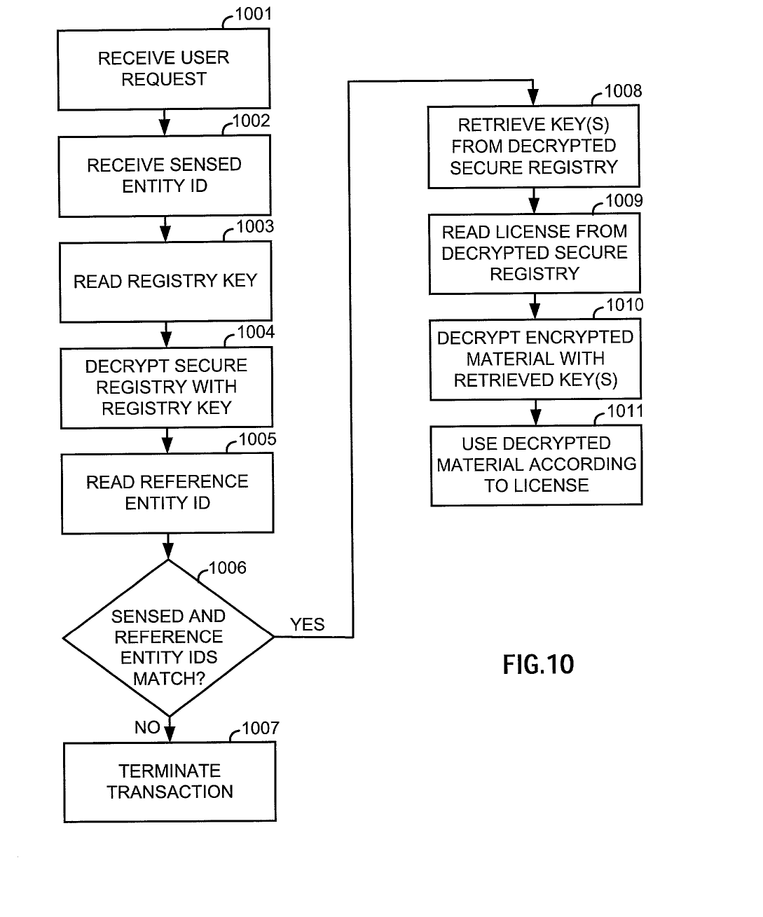

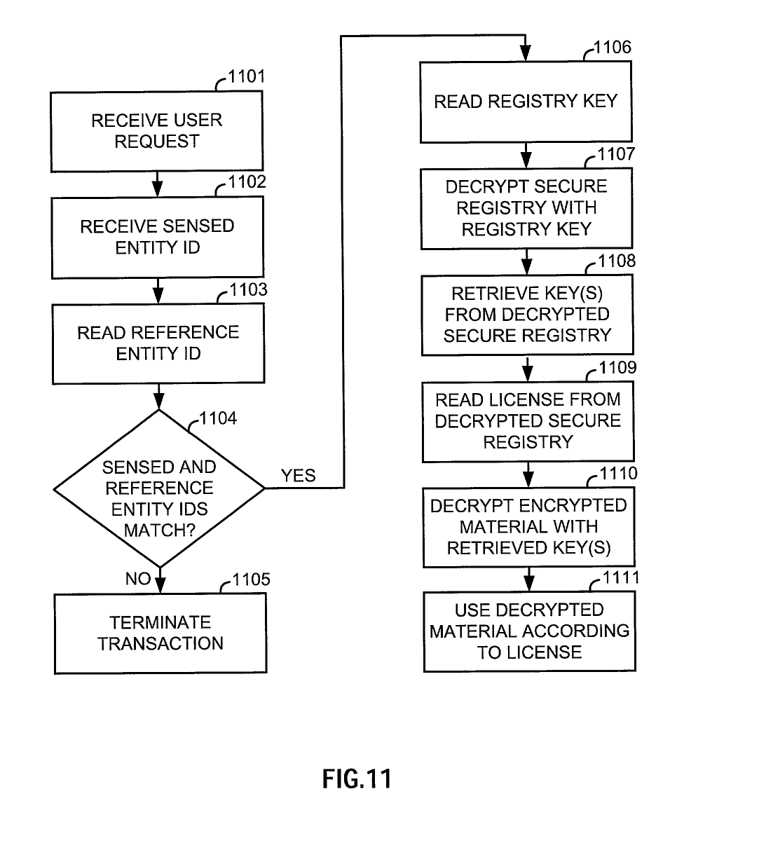

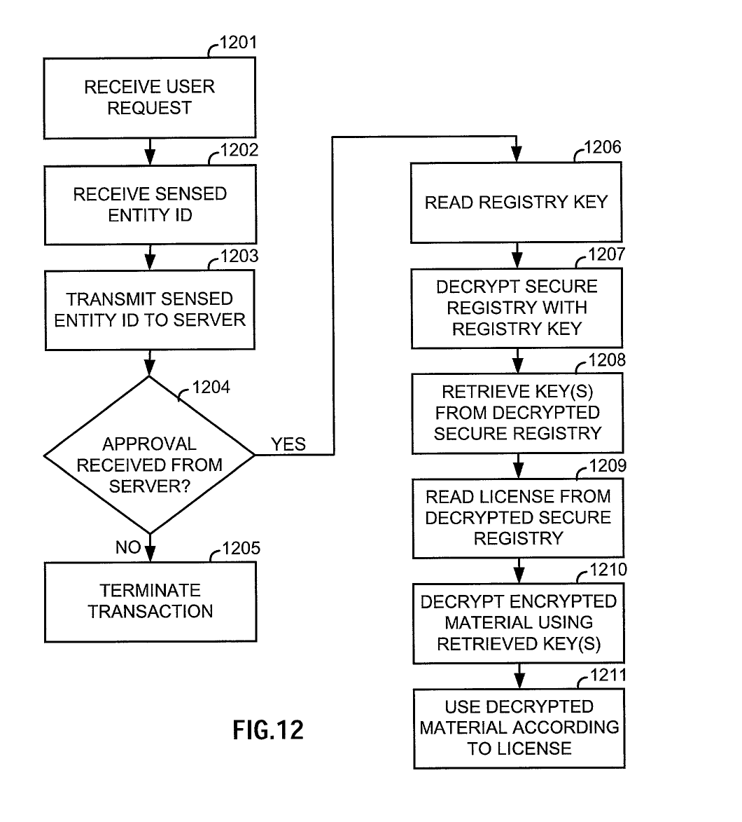

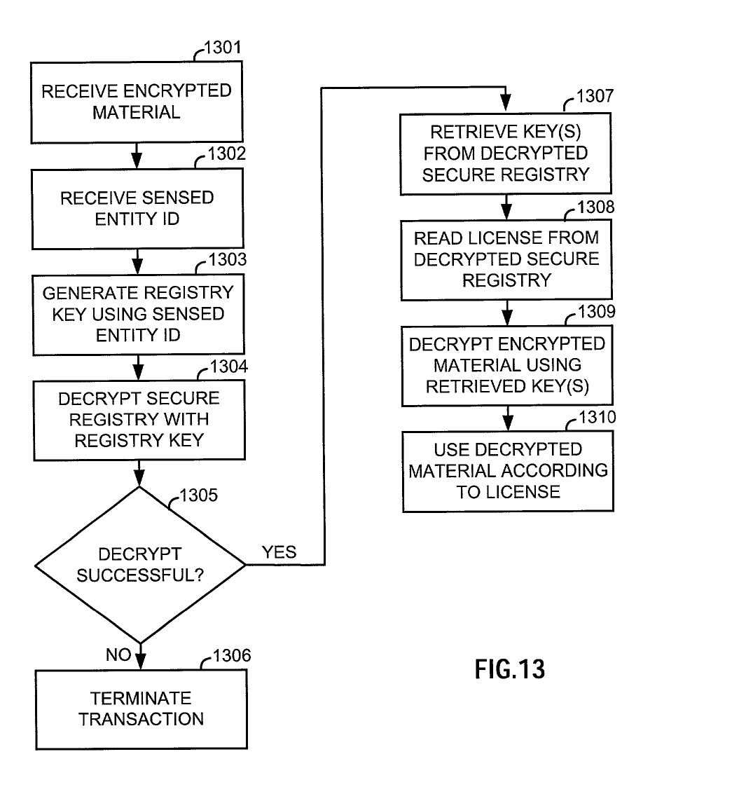

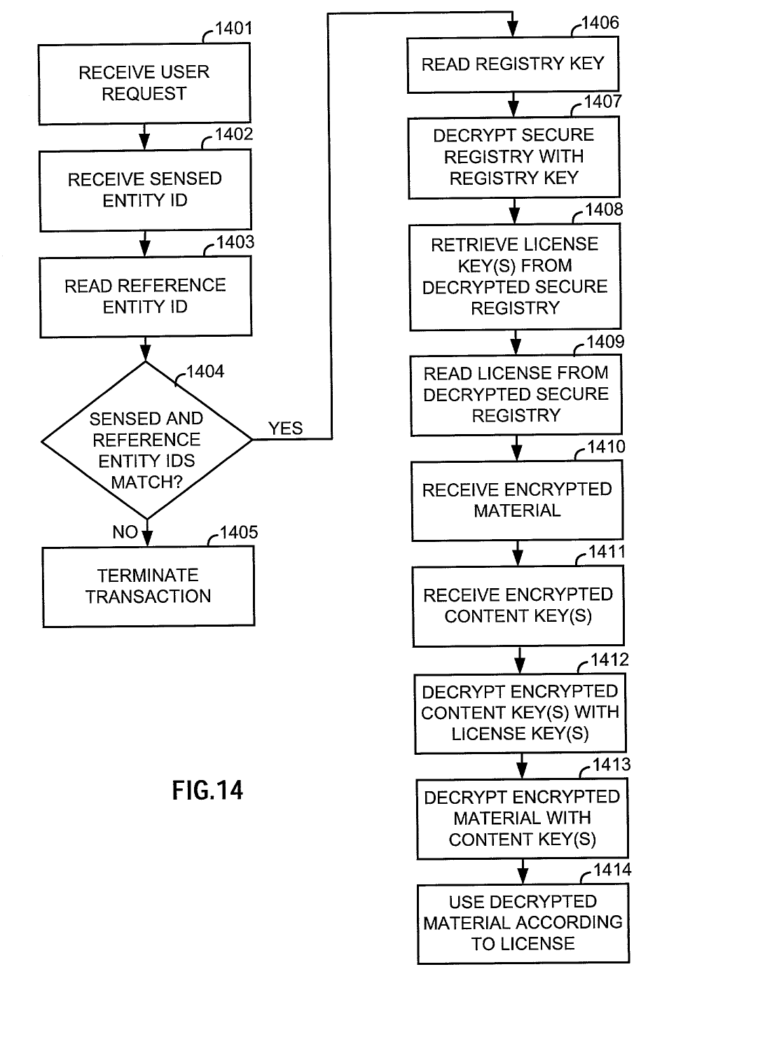

FIG. 10 illustrates a flow diagram of a method for accessing material that is implemented, for examples, by the host described in reference to FIG. 3. In 1001, a control module on a host receives a request from a user of the host to use material that is stored in encrypted form on the host. In 1002, in response to such request, the control module either receives after requesting from an entity or retrieves from storage in the entity, a sensed entity identification (“ID”). In 1003, the control module reads a registry key preferably provided by a registry key module. In 1004, the control module decrypts a secure registry on the host with the registry key to generate a decrypted version of the secure registry. In 1005, the control module receives or retrieves a reference entity identification (“ID”). In 1006, the control module compares the sensed entity ID with the reference entity ID to determine whether the IDs match. If they do not match (i.e., are different), then in 1007, the control module terminates the transaction.

On the other hand, if they do match (i.e., are the same), then in 1008, the control module reads or retrieves at least one key from the decrypted version of the secure registry, and in 1009, the control module reads or retrieves usage rights contained in a license from the decrypted version of the secure registry. The retrieved at least one key in this case may be at least one content key that is used to decrypt the requested encrypted material, or it may be at least one license key that is used to decrypt an encrypted at least one content key, which in turn, is used to decrypt the requested encrypted material. In 1010, the requested encrypted material is decrypted using the at least one key, and in 1011, the user is allowed to use the decrypted material according to the terms of the license. The control module may perform 1010 and 1011, or a plug-in module to a media or content player may perform 1010 and 1011 after securely receiving the at least one retrieved key from the control module and the encrypted material from the control module or other source.

FIG. 11 illustrates a flow diagram of a method for accessing material that is implemented, for example, by the host described in reference to FIG. 4. In 1101, a control module on a host receives a request from a user of the host to use material that is stored in encrypted form on the host. In 1102, in response to such request, the control module either receives after requesting from an entity or retrieves from storage in the entity, a sensed entity ID. In 1103, the control module receives or retrieves a reference entity ID. In 1104, the control module compares the sensed entity ID with the reference entity ID to determine whether the IDs match. If they do not match (i.e., are different), then in 1105, the control module terminates the transaction.

On the other hand, if they do match (i.e., are the same), then in 1106, the control module reads a registry key preferably provided by a registry key module. In 1107, the control module decrypts a secure registry on the host with the registry key to generate a decrypted version of the secure registry. In 1108, the control module reads or retrieves at least one key from the decrypted version of the secure registry, and in 1109, the control module reads or retrieves usage rights contained in a license from the decrypted version of the secure registry. The retrieved at least one key in this case may be at least one content key that is used to decrypt the requested encrypted material, or it may be at least one license key that is used to decrypt an encrypted at least one content key, which in turn, is used to decrypt the requested encrypted material. In 1110, the requested encrypted material is decrypted using the at least one key, and in 1111, the user is allowed to use the decrypted material according to the terms of the license. The control module may perform 1110 and 1111, or a plug-in module to a media or content player may perform 1110 and 1111 after securely receiving the at least one retrieved key from the control module and the encrypted material from the control module or other source.

FIG. 12 illustrates a flow diagram of a method for accessing material that is implemented, for example, by the system described in reference to FIG. 5. In 1201, a control module on a host receives a request from a user of the host to use material that is stored in encrypted form on the host. In 1202, the control module next receives a sensed entity ID uniquely corresponding to either the host or the user of the host. In 1203, the control module transmits the sensed entity ID to a remote server. In 1204, the control module receives either an approval or disapproval for the transaction from the remote server. Approval is received if the sensed entity ID matches with a reference entity ID stored on the remote server. Conversely, a disapproval of the transaction is received if the there is no match.

In 1205, the control module terminates the transaction if a disapproval of the transaction is received. On the other hand, if approval is received, in 1206, the control module reads a registry key provided by a registry key module. In 1207, the control module decrypts a secure registry on the host with the registry key to generate a decrypted version of the secure registry. In 1208, the control module reads or retrieves at least one key from the decrypted version of the secure registry that is useful for accessing the encrypted material. In one embodiment, the at least one key is at least one content key (KC) used for decrypting the encrypted material. In another embodiment, the at least one key is at least one license key (KL) used for decrypting an encrypted version of the at least one content key (KC). In 1209, the control module reads or retrieves usage rights contained in a license from the decrypted version of the secure registry.

In 1210, the requested encrypted material is decrypted using the retrieved keys. In one embodiment, where the at least one key is at least one content key (KC), the at least one content key (KC) is used to directly decrypt the encrypted material. In another embodiment, where the at least one key is at least one license key (KL), the at least one license key (KL) is used to decrypt the encrypted at least one content key (KC), which in turn, is used to decrypt the encrypted material. In 1211, the user is allowed to use the decrypted material according to the terms of the license. The control module may perform 1210 and 1211 or a player plug-in may perform them. In the case of the player plug-in performing 1210 and 1211, the control module first securely transmits the at least one key and the terms of the license to the player plug-in, using, for example, a conventional acknowledgement and key exchange procedure such as Diffie-Hellman.

FIG. 13 illustrates a flow diagram of a method for accessing material that is implemented, for examples, by the hosts described in reference to FIGS. 6 and 7. In 1301, a control module on a host receives a request from a user of the host to use material that is stored in encrypted form on the host. In 1302, the control module next receives a sensed entity ID uniquely corresponding to either the host or the user of the host. In 1303, the control module generates a registry key (KR) using the sensed entity ID. In 1304, the control module generates a decrypted version of an encrypted secure registry with the registry key (KR). Since the secure registry had been previously encrypted with a registry key (KR) corresponding to the original sensed entity ID, only a registry key generated from the original sensed entity ID is capable of decrypting the secure registry. The original sensed entity ID is also referred to herein as the reference entity ID.

In 1305, the control module makes a determination whether or not the decryption of the secure registry was successful. In this regard, it is implicit that the sensed entity ID must be the same as the reference entity ID in order for the generated registry key (KR) to successfully decrypt the encrypted secure registry. For this reason, the secure registry is also referred to as being entity-locked. If the decryption was unsuccessful, then in 1306, the control module terminates the transaction. On the other hand, if the decryption was successful, then in 1307, the control module reads or retrieves at least one key from the decrypted version of the encrypted secure registry; in 1308, the control module reads a license including usage rights from the decrypted version of the secure registry; in 1309, the encrypted material is decrypted using the retrieved at least one key; and in 1310, the user is allowed to use the decrypted material according to the terms of the license, wherein 1307˜1310 are performed in much the same manner as respectively corresponding 1208˜1211 of FIG. 12.

FIG. 14 illustrates a flow diagram of a method for accessing material that is implemented, for example, by the system described in reference to FIG. 9. In the method, 1401˜1407 are performed by a control module in much the same manner as respectively corresponding 1101˜1107 of FIG. 11. In this method, however, the at least one content key (KC) is encrypted with at least one license key (KL) and provided along with material that is encrypted with the at least one content key to the host. Therefore, in 1408, the control module reads or retrieves the at least one license key (KL) from the decrypted version of the secure registry, and in 1409, it reads or retrieves usage rights contained in a license from the decrypted version of the secure registry. In 1410 and 1411, the control module then receives the encrypted material and the encrypted at least one content key (KC), for example, in an MPEG-4 bit stream and its corresponding IPMP stream. In 1412˜1414, a plug-in module to a media or content player then, preferably, processes the received material “on-the-fly” after securely receiving the at least one license key (KL) and corresponding usage rights from the control module. The plug-in module preferably does this by generating a decrypted version of the encrypted at least one content key (KC) using the at least one license key (KL) in 1412, generating a decrypted version of the encrypted material using the decrypted version of the encrypted at least one content key (KC) in 1413, and allowing the user to use the decrypted version of the encrypted material according to the usage rights in 1414.

In the case where the received encrypted material and encrypted at least one content key (KC) are not processed “on-the-fly”, but stored instead in one or more files on the host such as 105 and 802 in FIG. 8, the control module simply processes the stored files according to the method of FIG. 14 without performing 1410 and 1412.

Although the various aspects of the invention have been described with respect to preferred embodiments, it will be understood that the invention is entitled to full protection within the full scope of the appended claims.

We claim:

1. An apparatus for accessing material, comprising:
a secure registry encrypted with a registry key and storing another key useful for decrypting material; and
a control module configured to decrypt said secure registry using said registry key for retrieval of said another key if a correct entity identification is received.

2. The apparatus according to claim 1, wherein said control module receives said material as streaming media, and is further configured to decrypt said material using said another key.

3. The apparatus according to claim 2, wherein said streaming media is in MPEG-4 format encrypted with at least one content key, and said control module receives said at least one content key encrypted with said another key.

4. The apparatus according to claim 3, wherein said another key comprises at least one license key corresponding to a license to use said material.

5. The apparatus according to claim 2, wherein said streaming media is in MPEG-4 format encrypted with at least one content key, and said control module receives said at least one content key encrypted with a public key of said apparatus.

6. The apparatus according to claim 5, wherein said another key comprises a private key of said apparatus.

7. The apparatus according to claim 1, further comprising a file including an encrypted version of said material, and said another key is useful for decrypting said encrypted version of said material.

8. The apparatus according to claim 7, wherein said material is in MPEG-4 format encrypted with at least one content key, and said at least one content key is provided encrypted with said another key.

9. The apparatus according to claim 8, wherein said another key comprises at least one license key corresponding to a license to use said material.

10. The apparatus according to claim 7, wherein said material is in MPEG-4 format encrypted with at least one content key, and said at least one content key is provided encrypted with a public key of said apparatus.

11. The apparatus according to claim 10, wherein said another key comprises a private key of said apparatus.

12. The apparatus according to claim 1, wherein said control module includes a control program and a replaceable software module linked to said control program so as to provide said registry key to said control program.

13. The apparatus according to claim 12, wherein said replaceable software module is a dynamic link library module.

14. The apparatus according to claim 12, wherein said replaceable software module provides both a new and old registry key to said control program so that said control program can decrypt said secure registry with said old registry key, encrypt said decrypted secure registry with said new registry key, and replace said secure registry encrypted with said old registry key with said secure registry encrypted with said new registry key.

15. The apparatus according to claim 12, wherein said replaceable software module has been provided by and linked to said control program by a server.

16. The apparatus according to claim 1, wherein said registry key is integrated into a binary executable code of said control module.

17. The apparatus according to claim 16, wherein a server has provided said control program to said apparatus.

18. The apparatus according to claim 1, wherein said control module includes a registry key generator that generates said registry key using a sensed entity identification.

19. The apparatus according to claim 18, wherein said sensed entity identification is unique for said apparatus.

20. The apparatus according to claim 18, wherein said sensed entity identification is unique for a hardware device connectable to said apparatus.

21. The apparatus according to claim 18, wherein said sensed entity identification is unique for a user of said apparatus.

22. The apparatus according to claim 1, wherein said control module includes a comparison module that determines whether said correct entity identification has been received by comparing a reference entity identification against a sensed entity identification.

23. The apparatus according to claim 22, wherein said sensed entity identification is unique for said apparatus.

24. The apparatus according to claim 23, wherein said sensed entity identification is a computer identification.

25. The apparatus according to claim 23, wherein said sensed entity identification is a network interface card identification.

26. The apparatus according to claim 23, wherein said sensed entity identification is a hard disk drive identification.

27. The apparatus according to claim 22, wherein said sensed entity identification is unique for a hardware device connectable to said apparatus.

28. The apparatus according to claim 27, wherein said sensed entity identification is a smartcard identification.

29. The apparatus according to claim 27, wherein said sensed entity identification is a content storage unit identification.

30. The apparatus according to claim 22, wherein said sensed entity identification is unique to a user of said apparatus.

31. The apparatus according to claim 30, wherein said sensed entity identification is a credit card number.

32. The apparatus according to claim 30, wherein said sensed entity identification is a predefined user identification.

33. The apparatus according to claim 30, wherein said sensed entity identification is a biometrics based identification.

34. The apparatus according to claim 33, wherein said biometrics based identification is a fingerprint of said user of said apparatus.

35. The apparatus according to claim 33, wherein said biometrics based identification is a speech of said user of said apparatus.

36. The apparatus according to claim 1, wherein a remote server determines whether said correct entity identification is received.

37. The apparatus according to claim 1, wherein said control module comprises a processor and a control program running on said processor.

38. The apparatus according to claim 1, wherein said control module includes logic circuitry.

39. The apparatus according to claim 1, wherein said control module is license-enabled to a unique identification of said apparatus.

40. The apparatus according to claim 1, wherein said secure registry further stores information related to said material.

41. The apparatus according to claim 40, wherein said information related to said material includes usage rights included in a license for said material.

42. A method for accessing material, comprising:
decrypting a secure registry with a registry key;
retrieving another key from said decrypted secure registry; and
decrypting encrypted material using said another key to access said material.

43. The method according to claim 42, further comprising receiving said encrypted material as streaming media.

44. The method according to claim 43, wherein said streaming media is in MPEG-4 format encrypted with at least one content key, and further comprising receiving said at least one content key encrypted with said another key.

45. The method according to claim 44, wherein said decrypting encrypted material using said another key to access said material, comprises:
decrypting said at least one content key with said another key; and
decrypting said encrypted material with said at least one content key to access said material.

46. The method according to claim 45, wherein said another key comprises at least one license key corresponding to a license to use said material.

47. The method according to claim 43, wherein said streaming media is in MPEG-4 format encrypted with at least one content key, and further comprising receiving said at least one content key encrypted with a public key of a recipient of said material.

48. The method according to claim 47, wherein said another key comprises a private key of said recipient of said material.

49. The method according to claim 48, wherein said decrypting encrypted material using said another key to access said material, comprises:
decrypting said at least one content key with said private key; and
decrypting said encrypted material with said at least one content key to access said material.

50. The method according to claim 42, further comprising receiving said encrypted material as a file.

51. The method according to claim 50, wherein said file is in MPEG-4 format encrypted with at least one content key, and further comprising receiving said at least one content key encrypted with said another key.

52. The method according to claim 51, wherein said decrypting encrypted material using said another key to access said material, comprises:
decrypting said at least one content key with said another key; and
decrypting said encrypted material with said at least one content key to access said material.

53. The method according to claim 52, wherein said another key comprises at least one license key corresponding to a license to use said material.

54. The method according to claim 50, wherein said file is in MPEG-4 format encrypted with at least one content key, and further comprising receiving said at least one content key encrypted with a public key of a recipient of said material.

55. The method according to claim 54, wherein said another key comprises a private key of said recipient of said material.

56. The method according to claim 55, wherein said decrypting encrypted material using said another key to access said material, comprises:
decrypting said at least one content key with said private key; and
decrypting said encrypted material with said at least one content key to access said material.

57. The method according to claim 42, further comprising retrieving said registry key from a replaceable software module.

58. The method according to claim 57, further comprising prior to said decrypting encrypted material using said another key to access said material:
receiving a sensed entity identification; and
comparing a reference entity identification against said sensed entity identification;
wherein said decrypting encrypted material using said another key to access said material comprises decrypting encrypted material using said another key to access said material only if said reference entity identification matches said sensed entity identification.

59. The method according to claim 58, wherein said reference entity identification is stored in said secure registry along with said another key.

60. The method according to claim 58, wherein said reference entity identification is provided by said replaceable software module.

61. The method according to claim 42, further comprising retrieving said registry key from binary executable code of a control module.

62. The method according to claim 61, further comprising prior to said decrypting encrypted material using said another key to access said material:
receiving a sensed entity identification; and
comparing a reference entity identification against said sensed entity identification;
wherein said decrypting encrypted material using said another key to access said material comprises decrypting encrypted material using said another key to access said material only if said reference entity identification matches said sensed entity identification.

63. The method according to claim 62, wherein said reference entity identification is stored in said secure registry along with said another key.

64. The method according to claim 62, wherein said reference entity identification is integrated into said binary executable code of said control module along with said registry key.

65. The method according to claim 64, further comprising generating said registry key using a sensed entity identification.

66. The method according to claim 65, wherein said sensed entity identification is unique to a host.

67. The method according to claim 65, wherein said sensed entity identification is unique to a hardware device connectable to a host.

68. The method according to claim 65, wherein said sensed entity identification is unique to a user of a host.

69. The method according to claim 68, further comprising receiving said sensed entity identification from information entered into an input device by said user.

70. The method according to claim 69, wherein said input device is a keyboard.

71. The method according to claim 69, wherein said input device is a biometrics device.

72. The method according to claim 42, further comprising after said decrypted engrypted material using said another key to access said material:
using said material according to a license stored in said secure registry along with said another key.
